(19) United States
(12) Patent Application Publication
(10) Pub. No.: US 2003/0057701 A1
(43) Pub. Date: Mar. 27, 2003

(54) Pipe connection structure

(76) Inventor: Sung Jun Koo, Seoul (KR)

Correspondence Address: BIRCH STEWART KOLASCH & BIRCH, PO BOX 747, FALLS CHURCH, VA, 22040-0747, US

(21) Appl. No.: 10/251,967

(22) Filed: Sep. 23, 2002

(30) Foreign Application Priority Data
Sep. 22, 2001 (KR) 2001-29279

(51) Int. Cl. F16L 37/00

(52) U.S. Cl. 285/307; 285/340

(57) ABSTRACT

The present invention relates to a pipe connection structure further comprising an auxiliary seal ring for improving sealing performance, which is disposed within a connector.

The present invention provides a pipe connection structure for detachably connecting one end of one pipe serving as a male pipe to one end of another pipe with a connector formed thereon or coupled thereto by inserting the end of the male pipe into the connector. The connector includes a seal ring, a tension washer, a fixing ring, a push-button and a connection cap. The pipe connection structure further comprises an auxiliary sealing-ring groove formed in a portion of an inner surface of the connector which corresponds to the end of the male pipe inserted into the connector, and an auxiliary seal ring fitted into the auxiliary seal-ring groove, thereby preventing leakage of a fluid at a connected portion of the pipes.

According to the present invention, since the auxiliary seal ring for complementing the conventional seal ring is additionally provided within the connector, there is an advantage in that complete sealing performance can be maintained even when fluids such as liquid and gas are carried.

### BACKGROUND OF THE INVENTION

1. Field of the Invention

The present invention relates to a pipe connection structure having improved sealing performance.

2. Description of the Prior Art

Generally, welding is performed or a connector is utilized, in order to connect pipes for use in carrying a fluid such as gas and liquid.

When the welding is performed or the connector is utilized in such a way, the connection of the pipes is easily made. However, there is a problem in that a connected portion of the pipes is not separated and thus should be cut upon maintenance and disconnection of the pipes.

Under such circumstances, the present applicant has completely solved the problem by the invention disclosed in Korean Utility Model Registration No. 211198 entitled “Pipe Connection Structure” and previously filed and registered in the name of the present applicant, which will be briefly described as follows.

The pipe connection structure is constructed such that a seal ring 2, a tension washer 3, a fixing ring 4, a push-button 5 and a connection cap 6 are inserted into one side of a female pipe 1 to be assembled together, as shown in FIG. 1. Then, a tip end of the female pipe 1 is bent toward an outer periphery of the connection cap 6, as shown in FIG. 2. The usage and fixing principle of the pipe connection structure will be described below.

First, one end of a male pipe 7 is arranged to face the one side of the female pipe 1 into which such a connector has been completely assembled, and is then inserted into the female pipe 1. At this time, as shown in FIG. 2, a fixing piece 4a of the fixing ring 4 presses against an outer periphery of the male pipe 7 and performs the same function as a barb of a fishing hook. Thus, the male pipe 7 is fixed thereto not to be separated in a direction opposite to its insertion direction. Thereafter, if the male pipe 7 is intended to be disconnected, it can be made by simply pushing the push-button 5 inwardly. The inwardly pushed push-button 5 pushes the fixing piece 4, which has pressed against the outer periphery of the male pipe 7, in the opposite direction to release the fixing state. Thus, the male pipe 7 can be disconnected.

The aforementioned pipe connection structure has an advantage in that working time can be greatly reduced since the pipes can be easily connected to each other and the connected pipes can also be easily disconnected from each other even after completion of the connection thereof. Further, there is another advantage in that the pipe connection structure is very excellent in terms of economical efficiency since it is not necessary to cut the connected portion of the pipes and thus material costs of the pipes can be lowered.

However, since only the single seal ring 2 is in charge of the sealing performance at the connected portion of the pipes in the pipe connection structure mentioned above, there is a problem in that the pipe connection structure can be reasonably used for liquid fluids such as water but cannot be suitable for carrying gaseous fluids, such as various gases or liquid fluids under high pressure, due to strong possibility of leakage of the fluids resulting from weak sealing performance at the connected portion.

### SUMMARY OF THE INVENTION

Accordingly, the present invention is contemplated to solve the above problems in the prior art. An object of the present invention is to provide a pipe connection structure further including an auxiliary seal ring for improving sealing performance within a connector.

According to the present invention for achieving the object, there is provided a pipe connection structure for detachably connecting one end of one pipe serving as a male pipe to one end of another pipe with a connector formed thereon or coupled thereto by inserting the end of the male pipe into the connector. The connector includes a seal ring, a tension washer, a fixing ring, a push-button and a connection cap. The pipe connection structure further comprises an auxiliary sealing-ring groove formed in a portion of an inner surface of the connector which corresponds to the end of the male pipe inserted into the connector, and an auxiliary seal ring fitted into the auxiliary seal-ring groove, thereby preventing leakage of a fluid at a connected portion of the pipes.

### BRIEF DESCRIPTION OF THE DRAWINGS

The above and other objects and features of the present invention will become apparent from the following description of a preferred embodiment given in conjunction with the accompanying drawings, in which:

FIG. 1 is an exploded perspective view of a conventional pipe connection structure;

FIG. 2 is a sectional view of the conventional pipe connection structure;

FIG. 3 is an exploded perspective view of a pipe connection structure according to the present invention; and

FIG. 4 is a sectional view of the pipe connection structure according to the present invention.

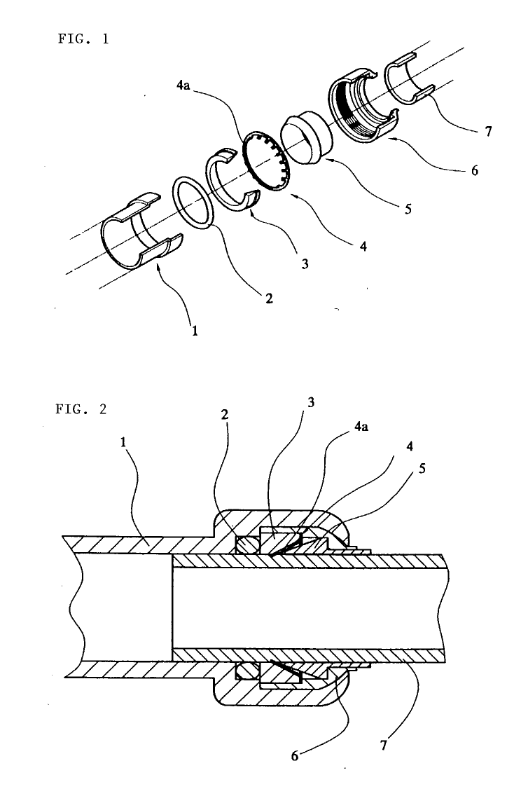

### DETAILED DESCRIPTION FOR PREFERRED EMBODIMENT

Hereinafter, a pipe connection structure according to a preferred embodiment of the present invention will be described in detail with reference to the accompanying drawings.

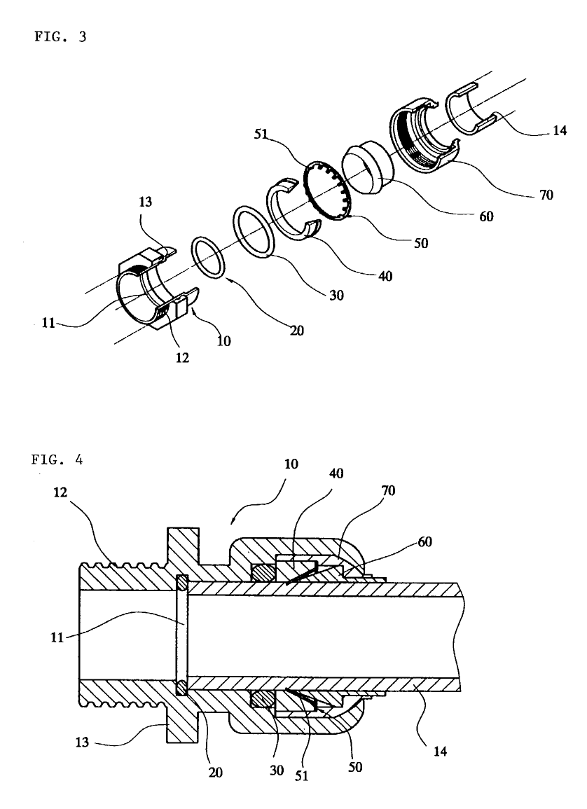

FIG. 3 shows an exploded perspective view of the pipe connection structure according to the present invention, and FIG. 4 shows a sectional view of the pipe connection structure according to the present invention.

As shown in these figures, the pipe connection structure according to the present invention includes a connector 10 provided with a seal ring 30, a tension washer 40, a fixing ring 50, a push-button 60 and a connection cap 70 therein in the same manner as the invention disclosed in Korean Utility Model Registration No. 211198 entitled “Pipe Connection Structure” and previously filed and registered in the name of the present applicant. In addition to the above constitution, an auxiliary seal-ring groove 11 is further formed in an inner surface of the connector 10, and an auxiliary seal ring 20 is additionally installed in the auxiliary seal-ring groove 11.

At this time, it is preferred that the auxiliary seal-ring groove 11 be concavely formed in a portion of the inner surface of the connector 10, which corresponds to an end of a male pipe 14 upon connection of the male pipe 14 to the connector 10, as shown in FIGS. 3 and 4.

The auxiliary seal ring 20 is made of the same material as the seal ring 30. However, the auxiliary seal rings 20 is formed to have a diameter slightly smaller than that of the seal ring 30 and fitted into the auxiliary seal-ring groove 11, as shown in the figures.

After the auxiliary seal ring 20 is fitted into the auxiliary seal-ring groove 11 in such a way, the seal ring 30, the tension washer 40, the fixing ring 50, the push-button 60 and the connection cap 70 are sequentially inserted into the connector 10. Then, a tip end of the connector 10 is bent as shown in FIG. 4.

Meanwhile, although the connector 10 of the present invention can be integrally formed on one side of a female pipe, it is preferred that the connector be formed as a separate part, as shown in FIGS. 3 and 4. The reason is that piping can be made by using two general pipes without manufacturing a special female pipe if the connector is formed as the separate part in such a way. To this end, one end of the connector 10 is, of course, formed with a threaded portion 12 for use in connection to the female pipe, and a screwing head portion 13 is also formed on an outer surface of the connector 10 so that the connector can be screwed into the female pipe by using a proper tool upon connection of the connector to the female pipe.

The male pipe 14 is connected to the female pipe by using the connector 10 according to the present invention which has the auxiliary seal-ring groove 11 additionally formed in the inner surface of the connector 10 and the auxiliary seal ring 20 installed in the auxiliary seal-ring groove 11, and the end of the male pipe 14 comes into close contact with the auxiliary seal ring 20 as shown in FIG. 4. Thus, sealing performance at the connected portion of the pipes is further improved. That is, although sealing action was made only on an outer periphery of the male pipe 14 by using only the single seal ring 30 in the prior art, the auxiliary seal ring 20 in addition to the seal ring 30 performs additional sealing action at the end of the male pipe 14 in the present invention. Consequently, thanks to the double sealing effects, the sealing performance can be much more improved.

As can be clearly understood from the above description, according to the present invention, since the auxiliary seal ring 20 is additionally provided, as a complement to the conventional seal ring 30, within the connector 10, there is an advantage in that complete sealing performance can be maintained even when fluids such as liquid and gas are carried.

Although the present invention has been described in connection with the preferred embodiment thereof, it is merely an example of the present invention. It will be understood by a person skilled in the art that various modifications, changes and equivalents thereof can be made thereto without departing from the spirit and scope of the present invention.

What is claimed is:

1. A pipe connection structure for detachably connecting one end of one pipe serving as a male pipe to one end of another pipe with a connector formed thereon or coupled thereto by inserting the end of the male pipe into the connector, said connector including a seal ring, a tension washer, a fixing ring, a push-button and a connection cap, comprising:
an auxiliary sealing-ring groove (11) formed in a portion of an inner surface of the connector (10) which corresponds to the end of the male pipe (14) inserted into the connector; and
an auxiliary seal ring (20) fitted into the auxiliary seal-ring groove (11), thereby preventing leakage of a fluid at a connected portion of the pipes.
